(19) United States
(12) Patent Application Publication
(10) Pub. No.: US 2016/0178736 A1
(43) Pub. Date: Jun. 23, 2016

(54) LIDAR SYSTEM

(71) Applicant: HANWHA TECHWIN CO., LTD., CHANGWON-SI (KR)

(72) Inventor: Young Dae CHUNG, Changwon-si (KR)

(73) Assignee: HANWHA TECHWIN CO., LTD., CHANGWON-SI (KR)

(21) Appl. No.: 14/702,814

(22) Filed: May 4, 2015

(30) Foreign Application Priority Data
Dec. 19, 2014 (KR) 10-2014-0184967

(51) Int. Cl. G01S 7/481; G01S 17/02

(52) U.S. Cl. CPC G01S 7/4818; G01S 17/02; G01S 7/4813

(57) ABSTRACT

Provided is a light detection and ranging (LIDAR) system. The LIDAR system includes: a housing including a first region and a second region, the second region including a plurality of openings; a laser disposed in the first region of the housing and configured to emit light; a plurality of optical fibers disposed in the second region, and configured to receive, at one ends thereof, and transmit, at the other ends thereof, the light emitted from the laser to an outside of the housing through the plurality of openings; and a detector configured to receive the light transmitted from the plurality of optical fibers to the outside and reflected from the outside, and convert the received reflected light into an electrical signal.

### CROSS-REFERENCE TO THE RELATED APPLICATION

This application claims priority from Korean Patent Application No. 10-2014-0184967, filed on Dec. 19, 2014, in the Korean Intellectual Property Office, the disclosure of which is incorporated herein in its entirety by reference.

### BACKGROUND 1. Field

Apparatuses and methods consistent with exemplary embodiments relate to light detection and ranging (LIDAR) systems, and more particularly, to LI DAR systems that may sense a wide region simultaneously without rotation.

2. Description of the Related Art

A light detection and ranging (LIDAR) system irradiates a laser to an object and receives a light reflected from the object, thereby sensing a distance to the object, a direction, a speed, a temperature, a material distribution, and concentration characteristics.

The LIDAR system has been used in various fields such as weather observation, distance measurement, etc. The LIDAR system has also been researched for technologies for satellite-based weather observation, unmanned robot sensors, unmanned vehicles, and three-dimensional (3D) image modeling.

Recently, research has been conducted on a rotary LIDAR system having a laser irradiating unit designed to rotate in order to sense objects disposed in various directions with respect to an installation position of the LIDAR system.

However, since the rotary LIDAR system includes a driving motor and a power supply for driving a rotator, the system size and the power consumption increase and the system configuration becomes complicated.

### SUMMARY

Exemplary embodiments of the inventive concept provide a light detection and ranging (LIDAR) system that may sense objects disposed in various directions with respect to an installation position of the LIDAR system, simultaneously without rotation of a laser included therein.

Various aspects of the inventive concept will be set forth in part in the description which follows and, in part, will be apparent from the description, or may be learned by practice of the presented exemplary embodiments.

According to one or more exemplary embodiments, there is provided a LIDAR system which may include: a housing including a first region and a second region, the second region including a plurality of openings; a laser disposed in the first region of the housing and configured to emit light; a plurality of optical fibers disposed in the second region, and configured to receive, at one ends thereof, and transmit, at the other ends thereof, the light emitted from the laser to an outside of the housing through the plurality of openings; and a detector configured to receive the light transmitted from the plurality of optical fibers to the outside and reflected from the outside, and convert the received reflected light into an electrical signal.

The plurality of optical fibers may include at least four optical fibers configured to transmit the light emitted from the laser in different directions with respect to the housing.

Two adjacent optical fibers among the at least four optical fibers may transmit the light emitted from the laser in directions perpendicular to each other, and two non-adjacent optical fibers among the at least four optical fibers may transmit the light emitted from the laser in directions opposite to each other.

The LIDAR system may further include a first optical system disposed between the laser and the plurality of optical fibers, and configured to process the light emitted from the laser and output the processed light into the plurality of optical fibers.

The first optical system may process the light emitted from the laser such that a cross section of a beam of the processed light is greater than or equal to a cross section of all optical fibers including the plurality of optical fibers in the LIDAR system.

All optical fibers in the LIDAR system may be bundled at the one ends facing the first optical system.

The first optical system may include at least one positive lens and at least one negative lens to control refractive power.

The first optical system may include: a beam expander controlling a diameter of the light emitted from the laser; and a diffuser uniformly distributing or diffusing the diameter-controlled light.

The LIDAR system may further include a second optical system disposed at the other ends of the optical fibers corresponding to the openings, and configured to adjust at least one of a diameter and a divergence angle of the light output from the optical fibers before transmitting to the outside.

The detector may include a plurality of converters disposed to be paired with the plurality of optical fibers respectively.

The LIDAR system may further include a plurality of light inlets disposed at a surface of the housing to correspond to the plurality of converters, respectively.

The LIDAR system may further include a focusing lens disposed in front of each of the plurality of converters and focusing the reflected light from outside into the housing.

The second region of the housing may include a first surface at which first openings among the plurality of openings are distributed with a first density and a second surface at which second openings among the plurality of openings are distributed with a second density smaller than the first density.

According to one or more exemplary embodiments, there is provided a LIDAR system which may include: a housing including a plurality of openings disposed at a surface thereof; and a plurality of optical fibers configured to receive, at one ends thereof, and transmit, at the other ends thereof, light emitted from a laser to an outside of the housing through the openings in different directions.

In the LIDAR system, the plurality of openings may be at least four openings, and the plurality of optical fibers may be at least four optical fibers. The LIDAR system may further include the laser.

The LIDAR system may further include a first optical system disposed between the laser and the at least four optical fibers and uniformly inputting the light emitted from the laser into the at least four optical fibers.

The first optical system may include: a beam expander expanding a diameter of the light emitted from the laser; and a diffuser uniformly diffusing or distributing the diameter-expanded light.

The LIDAR system may further include a second optical system disposed at the other ends corresponding to the openings and adjusting a diameter and a divergence angle of the light output from the optical fiber before transmitting to the outside.

The housing may include: a first region in which the laser is disposed; and a second region supported by the first region and including the at least four openings, wherein the second region is spherical.

The surface of the housing may include a first surface at which a plurality of openings are distributed with a first density and a second surface at which a plurality of openings are distributed with a second density smaller than the first density.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a perspective view schematically illustrating a light detection and ranging (LIDAR) system according to an exemplary embodiment;

FIG. 2 is a configuration diagram schematically illustrating the components of the LIDAR system of FIG. 1, according to an exemplary embodiment;

FIG. 3 is a conceptual diagram schematically illustrating the operations of components of the LIDAR system of FIG. 1, according to an exemplary embodiment;

FIG. 4 is a block diagram schematically illustrating the relationship between components of the LIDAR system of FIG. 1, according to an exemplary embodiment;

FIG. 5 is a conceptual diagram illustrating the directions of lights emitted from a LIDAR system, according to an exemplary embodiment; and

FIG. 6 is a conceptual diagram illustrating the densities of lights emitted from a LIDAR system, according to an exemplary embodiment.

### DETAILED DESCRIPTION OF THE EXEMPLARY EMBODIMENTS

Reference will now be made in detail to exemplary embodiments which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain various aspects of the inventive concept.

The exemplary embodiments in reference to the drawings will be described below in detail. However, it will be understood that the inventive concept is not limited to the exemplary embodiments and includes all modifications, equivalents, and substitutions falling within the spirit and scope of the inventive concept. In the following description, detailed descriptions of well-known functions or configurations will be omitted since they would unnecessarily obscure the subject matters of the inventive concept.

In the following description of the exemplary embodiments, like reference numerals denote like elements, and redundant descriptions thereof will be omitted.

In the following exemplary embodiments, although terms such as “first” and “second” may be used herein to describe various elements or components, these elements or components should not be limited by these terms. These terms are only used to distinguish one element or component from another element or component.

The terms used herein are for the purpose of describing exemplary embodiments only and are not intended to limit the inventive concept. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof.

Sizes of elements in the drawings may be exaggerated for convenience of description. In other words, since sizes and thicknesses of elements in the drawings are arbitrarily illustrated for convenience of description, the following exemplary embodiments are not limited thereto.

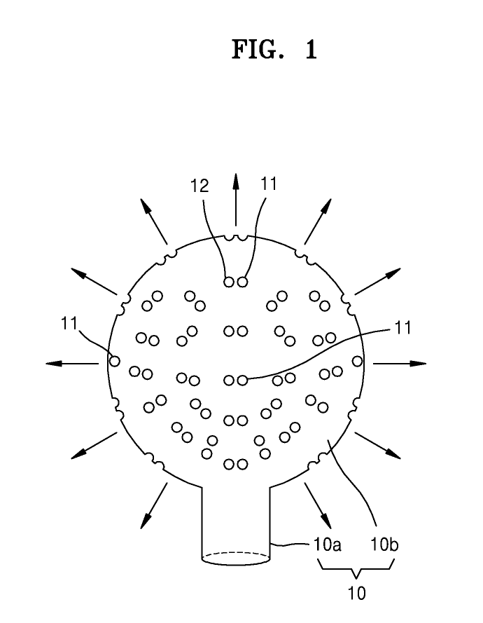

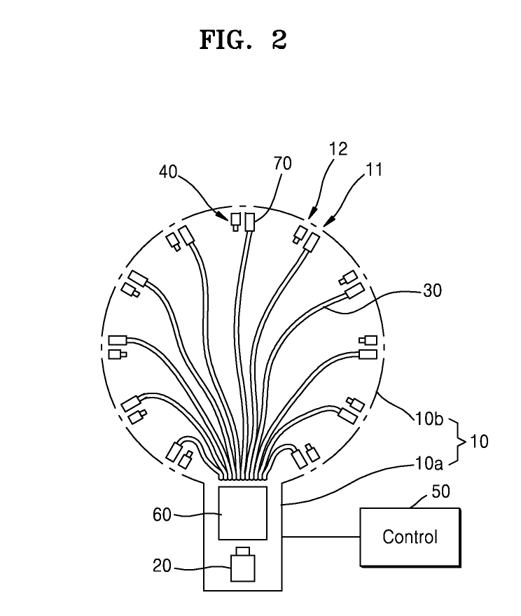

FIG. 1 is a perspective view schematically illustrating a light detection and ranging (LIDAR) system according to an exemplary embodiment. FIG. 2 is a configuration diagram schematically illustrating the components of the LIDAR system of FIG. 1, according to an exemplary embodiment.

Referring to FIGS. 1 and 2, the LIDAR system according to an exemplary embodiment may include a housing 10, in which a plurality of openings 11 are provided, a laser 20 disposed in the housing 10 and emitting light, a plurality of optical fibers 30 receiving light emitted from the laser 20, transmitting the received light to regions corresponding to the openings 11 respectively, and outputting light to an outside of the housing 10 through the openings 11, and a detector 40 receiving light reflected from the outside and input into the housing 10 and converting the received light into an electrical signal.

The housing 10 may include a first region 10a and a second region 10b supported by the first region 10a and having the openings 11 formed three-dimensionally at a surface thereof. According to an exemplary embodiment, the first region 10a may have a flat bottom surface to function as a support portion, and the second region 10b may have a spherical shape to irradiate a light in various directions. However, the inventive concept is not limited thereto, and the first region 10a and the second region 10b may be formed in various different shapes.

The laser 20 emitting light and a first optical system 60 may be disposed in the first region 10a, and the optical fibers 30 may be disposed in the second region 10b. The laser 20 may emit infrared light or visible light having a very narrow wavelength band, and the light emitted from the laser 20 may be expanded and uniformly distributed or diffused by the first optical system 60 and then input into the optical fibers 30.

One end of each of the optical fibers 30 may face the first optical system 60, the other end thereof may face one of the openings 11, and the light emitted from the other end of the optical fiber 30 may be emitted toward an outside of the housing 10 through the opening 11. The number of the openings 11 and the number of the optical fibers 30 may be four or more, and the range and resolution of an external environment that may be measured with respect to the housing 10 may vary according as the number of the openings 11 and the number of the optical fibers 30 increase. When the number of the openings 11 and the number of the optical fibers 30 is greater than or equal to a predetermined value, the external environment disposed in all directions (i.e., a 360-degree range) with respect to the housing 10 may be accurately measured.

The optical fiber 30 is an optical element that is flexible and has a very small thickness. The optical fiber 30 transmits light, which is input through one end of the optical fiber 30, to the other end thereof by total reflection inside the optical fiber 30. The optical fiber 30 according to an exemplary embodiment may transmit light, which is input through one end facing the first optical system 60, to the opening 11 with a minimized loss. Since the optical fiber 30 is flexible and has a very small thickness, a large number of optical fibers 30 may be disposed in the housing 10 to freely transmit light to desired regions.

According to an exemplary embodiment, a plurality of optical fibers 30 may output light in different directions with respect to the housing 10, and the light emitted from the optical fibers 30 may be output through the openings 11 in various directions with respect to the housing 10. The light output in various directions may be reflected from objects disposed outside the housing 10 or from particles floating in the air, and at least a portion of the reflected light may be input into the housing 10.

The detector 40 may receive light reflected from the outside and input into the housing 10 and convert the received light into an electrical signal. According to an exemplary embodiment, the housing 10 may include a plurality of light inlets 12 disposed at a surface of the housing 10 to input light into the housing 10, and the light inlets 12 may be disposed to be paired with the openings 11. That is, a plurality of detectors 40 disposed to correspond to a plurality of light inlets 12 respectively may be disposed to be paired with a plurality of optical fibers 30 respectively.

The LIDAR system according to an exemplary embodiment may further include a controller 50 that controls the laser 20 and processes a signal obtained from the detector 40. The controller 50 may receive signals obtained from the detectors 40 and then collect and match the received signals to derive desired information such as the presence and distance of an object disposed outside the housing 10.

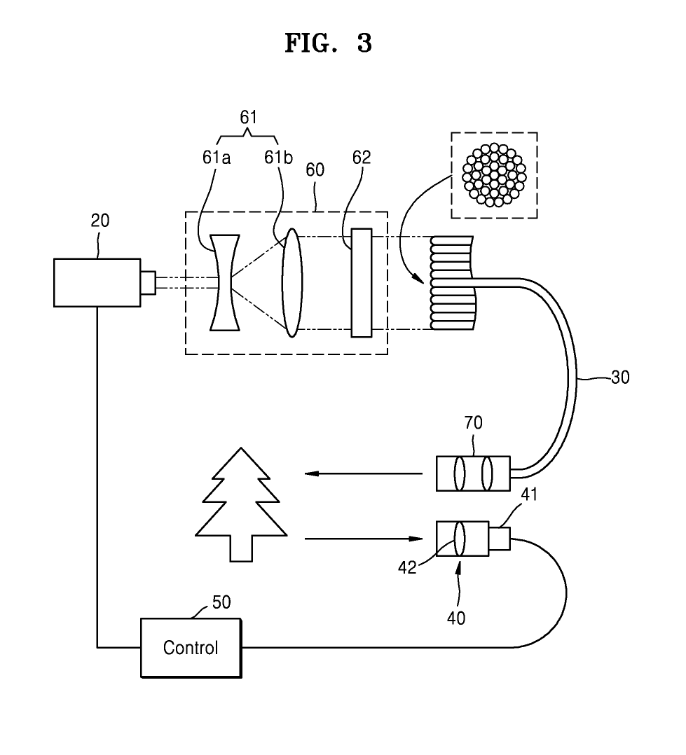

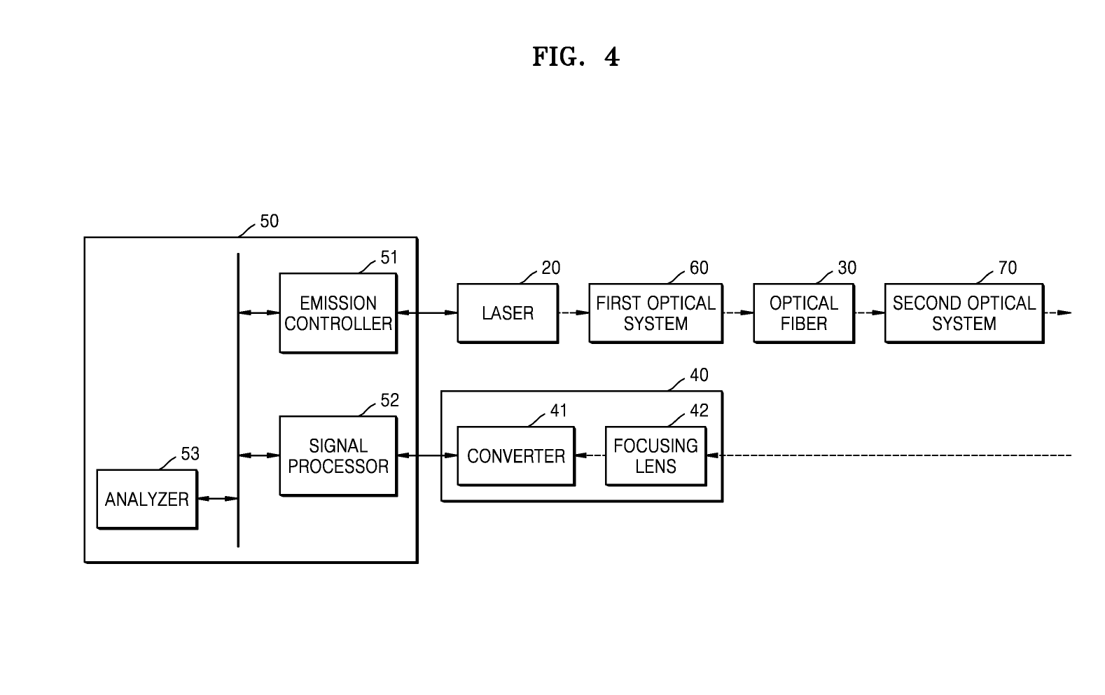

FIG. 3 is a conceptual diagram schematically illustrating operations of components of the LIDAR system of FIG. 1. FIG. 4 is a block diagram schematically illustrating relationships between components of the LIDAR system of FIG. 1.

Referring to FIG. 3, light emitted from the laser 20 may be input through the first optical system 60 into the optical fiber 30. The first optical system 60 may include a beam expander 61 expanding a diameter of a light beam emitted from the laser 20 and a diffuser 62 uniformly distributing or diffusing the diameter-expanded light beam.

For example, the beam expander 61 may include a negative lens 61a and a positive lens 61b, and the diameter of a light beam may increase as the refractive power of the negative lens 61a and the positive lens 61b increases. The light beam should have such a diameter so as for a cross section of the light beam to cover all of the optical fibers 30 at a position in the housing 10 where the optical fibers 30 are bundled together, and the negative lens 61a and the positive lens 61 b may have a suitable refractive power to realize such light beam.

The diameter-expanded light beam may be input into the diffuser 62 and may be converted by the diffuser 62 into a light beam having a uniform intensity throughout a cross section of the light beam. The diffuser 62 may form a uniformly distributed or diffused light beam by diffusing, scattering, or spreading out a light beam input from the beam expander 61 in various ways.

Since the first optical system 60 is disposed between the laser 20 and the optical fibers 30, the laser 20 may be used to input a light beam of a substantially uniform intensity into the optical fibers 30. Since the ends of the optical fibers 30 facing the first optical system 60 should be disposed in a range to be covered by the uniformly distributed or diffused light beam, they may be assembled densely in the form of a bundle.

The light beam input through one end of each optical fiber 30 may propagate along a core portion of the optical fiber 30 to the other end of the optical fiber 30, and the light beam that has propagated to the other end of the optical fiber 30 may be emitted to the outside the housing 10 (see FIG. 1) through the opening 11 (see FIG. 1).

A second optical system 70 may be disposed at the other end of the optical fiber 30 corresponding to the opening 11 (see FIG. 1). The second optical system 70 may adjust a diameter and a divergence angle of the light beam emitted from the optical fiber 30, for example, by adjusting a distance between lenses by using two positive lenses. The second optical system 70 may be attached to the other end of the optical fiber 30 or may be spaced apart from the other end of the optical fiber 30.

The divergence angle of the light beam emitted to the outside of the housing 10 (see FIG. 1) through the second optical system 70 may be smaller than or equal to about 10 degrees in order to propagate the light beam to a distant place while minimizing a loss of light. A portion of the light beam emitted outside the housing 10 (see FIG. 1) may be reflected by an external object and then input into the housing 10 (see FIG. 1).

The housing 10 (see FIG. 1) may include a plurality of light inlets 12 at a surface thereof, and the detector 40 may be disposed in the housing 10 (see FIG. 1) corresponding to the light inlet 12. The detector 40 may include a plurality of converters 41 disposed to be paired with the optical fibers 30 respectively, and a focusing lens 42 disposed in front of each of the converters 41.

Light input or reflected from the outside of the housing 10 through the light inlet 12 may be focused by the focusing lens 42 and then input into the converter 41, and the converter 41 may convert the input light into an electrical signal. For example, the converter 41 may be a photodiode (PD) but is not limited thereto.

Referring to FIG. 4, the controller 50 may be electrically connected to the laser 20 and the detector 40. The controller 50 may include an emission controller 51 controlling an operation of the laser 20, a signal processor 52 processing an electrical signal converted by the detector 40 and an analyzer 53 analyzing the processed electrical signal.

The signal processor 52 and the analyzer 53 may collect electrical signals received from the detectors 40 and match the collected electrical signals with light reflection positions, thereby calculating distances of objects disposed in various directions around the housing 10 (see FIG. 1) and restoring shapes of the objects.

At least one of the converter 41 of the detector, the emission controller 51, the signal processor 52 and the analyzer included in the controller 50 may be embodied as various numbers of hardware, software and/or firmware structures that execute respective functions described above, according to an exemplary embodiment. For example, at least one of these components, elements or units may use a direct circuit structure, such as a memory, processing, logic, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of one component, element or unit may be performed by another of these components, element or units. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

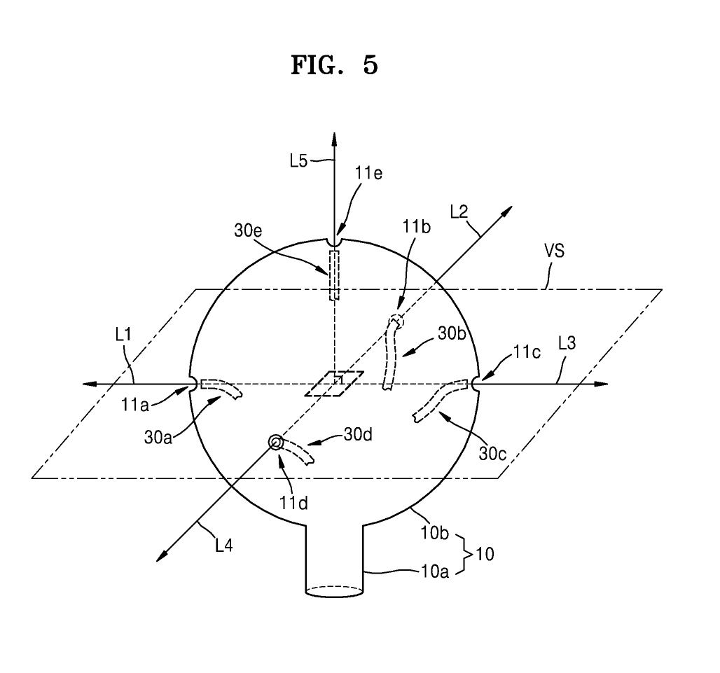

FIG. 5 is a conceptual diagram illustrating directions of light beams emitted from a LIDAR system, according to an exemplary embodiment.

Referring to FIG. 5, the housing 10 including the first region 10a and the second region 10b may include a plurality of openings 11a, 11b, 11c, 11d, and 11e disposed at the surface thereof, and a plurality of optical fibers 30a, 30b, 30c, 30d, and 30e may be disposed in the housing 10 corresponding to the openings 11a, 11b, 11c, 11d, and 11e, respectively.

Two adjacent optical fibers 30a and 30b among the optical fibers 30a, 30b, 30c, 30d, and 30e may output light beams from the housing 10 in directions that are at an angle of about 90 degrees to each other, and two non-adjacent optical fibers 30a and 30c among the optical fibers 30a, 30b, 30c, 30d, and 30e may output light beams from the housing 10 in directions that are at an angle of about 180 degrees to each other.

FIG. 5 illustrates an exemplary case where five openings 11a, 11b, 11c, 11d, and 11e and five optical fibers 30a, 30b, 30c, 30d, and 30e are used. In this case, light beams L1, L2, L3, L4, and L5 emitted in different directions from the second region 10b of the housing 10 may be emitted in four directions perpendicular to each other in a virtual plane VS and in one direction perpendicular to the virtual plane VS.

However, the inventive concept is not limited thereto, and the LIDAR system according to an exemplary embodiment may include four optical fibers that emit light beams in the other four directions other than the direction perpendicular to the virtual plane VS. The LIDAR system according to another exemplary embodiment may further include a plurality of openings 11 (see FIG. 2) and optical fibers 30 (see FIG. 2) disposed between five openings 11a, 11b, 11c, 11d, and 11e and five optical fibers 30a, 30b, 30c, 30d, and 30e illustrated in FIG. 5.

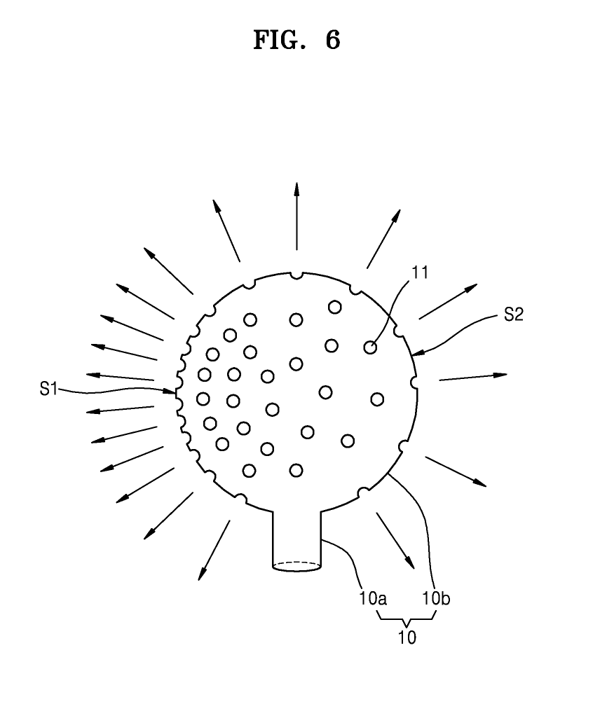

FIG. 6 is a conceptual diagram illustrating a density of light emitted from a LIDAR system, according to an exemplary embodiment.

Referring to FIG. 6, the LIDAR system according to an exemplary embodiment may include a housing 10 including a first region 10a and a second region 10a supported by the first region 10a and including a plurality of openings 11. The second region 10b may include a first surface S1 at which a plurality of openings 11 are distributed with a first density and a second surface S2 at which a plurality of openings 11 are distributed with a second density smaller than the first density.

Thus, the density of light beams emitted from the openings 11 included in the first surface S1 may be greater than the density of light beams emitted from the openings 11 included in the second surface S2. For example, the LIDAR system may be attached to a vehicle to measure objects around the vehicle. In this case, the density of light beams output in a direction requiring accurate measurement may be relatively great, and the density of light beams output in a direction not requiring accurate measurement may be relatively small. By this configuration, desired information may be obtained while minimizing the use of optical fibers 30 (see FIG. 2).

As described above, according to the above exemplary embodiments, the LIDAR system may sense objects, which are disposed in various directions with respect to an installation position of the LIDAR system, simultaneously without rotation. Also, the LIDAR system is compact and has a minimized weight.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A light detection and ranging (LIDAR) system comprising:
a housing comprising a first region and a second region, the second region comprising a plurality of openings;
a laser disposed in the first region of the housing and configured to emit light;
a plurality of optical fibers disposed in the second region, and configured to receive, at one ends thereof, and transmit, at the other ends thereof, the light emitted from the laser to an outside of the housing through the plurality of openings; and
a detector configured to receive the light transmitted from the plurality of optical fibers to the outside and reflected from the outside, and convert the received reflected light into an electrical signal.

2. The LIDAR system of claim 1, wherein the plurality of optical fibers comprise at least four optical fibers configured to transmit the light emitted from the laser in different directions with respect to the housing.

3. The LIDAR system of claim 2, wherein two adjacent optical fibers among the at least four optical fibers are configured to transmit the light emitted from the laser in directions perpendicular to each other, and
wherein two non-adjacent optical fibers among the at least four optical fibers are configured to transmit the light emitted from the laser in directions opposite to each other.

4. The LIDAR system of claim 1, further comprising a first optical system disposed between the laser and the plurality of optical fibers, and configured to process the light emitted from the laser and output the processed light into the plurality of optical fibers.

5. The LIDAR system of claim 4, wherein the first optical system comprises:
a beam controller configured to control a diameter of the light emitted from the laser; and
a diffuser configured to uniformly diffuse the diameter-controlled light.

6. The LIDAR system of claim 4, further comprising a second optical system disposed at the other ends of the optical fibers corresponding to the openings, and configured to adjust at least one of a diameter and a divergence angle of the light output from the optical fibers before transmitting to the outside.

7. The LIDAR system of claim 1, further comprising an optical system disposed at the other ends of the optical fibers corresponding to the openings, and configured to adjust at least one of a diameter and a divergence angle of the light output from the optical fibers before transmitting to the outside.

8. The LIDAR system of claim 4, wherein the first optical system is configured to process the light emitted from the laser such that a cross section of a beam of the processed light is greater than or equal to a cross section of all optical fibers including the plurality of optical fibers in the LIDAR system.

9. The LIDAR system of claim 8, wherein all optical fibers in the LIDAR system are bundled at the one ends facing the first optical system.

10. The LIDAR system of claim 8, wherein the first optical system comprises at least one positive lens and at least one negative lens.

11. The LIDAR system of claim 8, further comprising a second optical system disposed at the other ends of the optical fibers corresponding to the openings, and configured to adjust at least one of a diameter and a divergence angle of the light output from the optical fibers before transmitting to the outside.

12. The LIDAR system of claim 1, wherein the detector comprises a plurality of converters disposed to be paired with the plurality of optical fibers, respectively.

13. The LIDAR system of claim 12, further comprising a plurality of light inlets disposed at a surface of the housing to correspond to the plurality of converters, respectively.

14. The LIDAR system of claim 12, further comprising a focusing lens disposed in front of each of the plurality of converters and configured to focus the received reflected light.

15. The LIDAR system of claim 1, wherein the second region of the housing comprises a first surface at which first openings among the plurality of openings are distributed with a first density and a second surface at which second openings among the plurality of openings are distributed with a second density smaller than the first density.

16. The LIDAR system of claim 15, further comprising at least one of a first optical system and a second optical system,
wherein the first optical system is configured to process the light emitted from the laser such that a cross section of a beam of the processed light is greater than or equal to a cross section of all optical fibers including the plurality of optical fibers in the LIDAR system, and
wherein the second optical system is configured to adjust at least one of a diameter and a divergence angle of the light output from the optical fibers before transmitting to the outside.

17. A light detection and ranging (LIDAR) system comprising:
a housing comprising a plurality of openings disposed at a surface thereof;
and a plurality of optical fibers configured to receive, at one ends thereof, and transmit, at the other ends thereof, light emitted from a laser to an outside of the housing through the openings in different directions.

18. The LIDAR system of claim 17, further comprising a first optical system configured to process the light emitted from the laser such that a cross section of a beam of the processed light is greater than or equal to a cross section of all optical fibers including the plurality of optical fibers in the LIDAR system.

19. The LIDAR system of claim 18, further comprising a second optical system configured to adjust at least one of a diameter and a divergence angle of the light output from the optical fibers before transmitting to the outside.

20. The LIDAR system of claim 17, wherein the surface of the housing comprises a first surface at which first openings among the plurality of openings are distributed with a first density and a second surface at which second openings among the plurality of openings are distributed with a second density smaller than the first density.
